(19) United States
(12) Patent Application Publication
(10) Pub. No.: US 2022/0269334 A1
(43) Pub. Date: Aug. 25, 2022

(54) Augmented Reality System

(71) Applicant: Volkswagen Aktiengesellschaft, Wolfsburg (DE)

(72) Inventor: Yasin Savci, Garbsen (DE)

(73) Assignee: Volkswagen Aktiengesellschaft, Wolfsburg (DE)

(21) Appl. No.: 17/612,901

(22) PCT Filed: Apr. 2, 2020
(86) PCT No.: PCT/EP2020/059452

§ 371 Date: Nov. 19, 2021

(30) Foreign Application Priority Data
May 21, 2019 (DE) 10 2019 207 454.5

(51) Int. Cl. G06F 3/01; G06F 3/0346; G06F 3/0354; G06F 3/038; G02B 27/01; G06T 19/00; H04W 4/80

(52) U.S. Cl. CPC G06F 3/011; G06F 3/0346; G06F 3/03542; G06F 3/0386; G02B 27/0101; G02B 27/0172; G06T 19/006; H04W 4/80; G02B 2027/0138; G02B 2027/014

(57) ABSTRACT

The invention relates to an augmented reality system with a headset and a control element, as well as a method for operating such an augmented reality system. The invention moreover relates to a control element of an augmented reality system.

### CROSS-REFERENCE TO RELATED APPLICATIONS

This application claims priority to German Patent Application No. DE 10 2019 207 454.5, filed on May 21, 2019 with the German Patent and Trademark Office. The contents of the aforesaid Patent Application are incorporated herein for all purposes.

### TECHNICAL FIELD

The invention relates to an augmented reality system (AR system) with a headset and a control element, as well as a method for operating such an augmented reality system. The invention moreover relates to a control element of an augmented reality system.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

An augmented reality system with a headset and a control element is disclosed in US 2017/0357333 A1 (incorporated by reference in its entirety). The control element disclosed in US 2017/0357333 A1 is pin-shaped and has an elongated middle part, on the end of which optical markers are provided. Moreover, the control element has a status LED and a switch.

### SUMMARY

An need exists to improve an AR system, or respectively to expand its functionality.

The need is addressed by the subject matter of the independent claims. Embodiments of the invention are described in the dependent claims, the following description, and the drawings.

### BRIEF DESCRIPTION OF THE DRAWINGS

FIG. 1 shows an exemplary embodiment of an augmented reality system with a headset and a pin-shaped control element data-linked to the headset;

FIG. 2 shows another exemplary embodiment of a control element for an augmented reality system according to FIG. 1;

FIG. 3 shows another exemplary embodiment of a control element for an augmented reality system according to FIG. 1;

FIG. 4 shows another exemplary embodiment of a control element for an augmented reality system according to FIG. 1;

FIG. 5 shows the augmented reality system according to FIG. 1 in an exemplary schematic diagram;

FIG. 6 shows a modification of the augmented reality system according to FIG. 5 in an exemplary schematic diagram;

FIG. 7 shows an exemplary application scenario for the augmented reality system;

FIG. 8 shows another exemplary application scenario for an aforementioned augmented reality system;

FIG. 9 shows another exemplary application scenario for an aforementioned augmented reality system; and

FIG. 10 shows another exemplary application scenario for an aforementioned augmented reality system.

### DESCRIPTION

The details of one or more embodiments are set forth in the accompanying drawings and the description below. Other features will be apparent from the description, drawings, and from the claims.

In the following description of embodiments of the invention, specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

Some embodiments provide a control element, in particular a pin-like/elongated control element, in particular a control element in the form of a pin, wherein the control element comprises a first marker and a second marker for determining the orientation of the control element, as well as a light source for emitting a light beam. The control element may also comprise a gyroscope, in particular according to the teaching of US 2017/037333 A1, for tracking, or respectively determining its orientation. Moreover, it is in particular provided that the control element comprises a CPU as well as a battery for the power supply.

It may be provided that the first marker is different from the second marker. It may in particular be provided that the light source-side marker is designed as a ring or comprises a ring. The light source may comprise visible light, the light beam may however also comprise UV light or infrared light. In some embodiments, the light source is a diode, or respectively a laser diode. The light beam may be individualized, for example by a pulse and/or a code. In this manner, when the code or pulse is communicated to the headset, or respectively is known by the headset, it may identify an object marked by the light beam in a very suitable manner. In an additional embodiment, the control element has a rangefinder, or respectively the light source is part of a rangefinder.

In some embodiments, the control element has a contour, a structure or a texture, or the like that allows, or respectively enables a haptic, or respectively manual recognition of the orientation of the control element. In some embodiments, the control element has an interface to a headset. In some embodiments, the interface is a wireless interface, or respectively an interface for wireless communication. In some embodiments, the control element has one or more control elements. These serve in particular to turn on the light source, and/or to trigger the recognition of a region marked by the light beam.

Some embodiments provide an augmented reality system with a headset that comprises a transparent display, by means of which a virtual image component may be depicted, wherein the headset has a camera assembly for recording an image of the environment of the headset as well as a tracking system for determining the position (and orientation) of the virtual image component on the transparent display depending on the image of the real environment, and wherein the augmented reality system has an aforementioned control element. A headset pursuant to this disclosure is in particular also a head-mounted display (HMD), or respectively data goggles or AR goggles. A suitable headset pursuant to this disclosure is for example the Hololens® by Microsoft®. A camera assembly pursuant to this disclosure is in particular a stereo camera assembly having at least two cameras. A tracking system pursuant to this disclosure is in particular a markerless tracking system.

It may be provided that the augmented reality system comprises at least two control elements and at least two headsets. These may for example form an interactive group (with two users).

In some embodiments, the headset and the control element are data-linked by means of an in particular wireless communication system.

In some embodiments, the headset or the augmented reality system has a local position-determining module for recognizing, or respectively for determining the position of a point or a region of the environment of the headset marked by the light beam.

Some embodiments provide a method for operating an aforementioned augmented reality system, wherein a point or a region of the environment of the augmented reality system is marked in the field of vision of the transparent display by the light beam.

In some embodiments, the marked point or region is assigned a local position and/or a global position. In some embodiments, the local position or the global position is assigned a function. In some embodiments, the marked region is measured and/or separated.

Reference will now be made to the drawings in which the various elements of embodiments will be given numerical designations and in which further embodiments will be discussed.

Specific references to components, process steps, and other elements are not intended to be limiting. Further, it is understood that like parts bear the same or similar reference numerals when referring to alternate FIGS. It is further noted that the FIGS. are schematic and provided for guidance to the skilled reader and are not necessarily drawn to scale. Rather, the various drawing scales, aspect ratios, and numbers of components shown in the FIGS. may be purposely distorted to make certain features or relationships easier to understand.

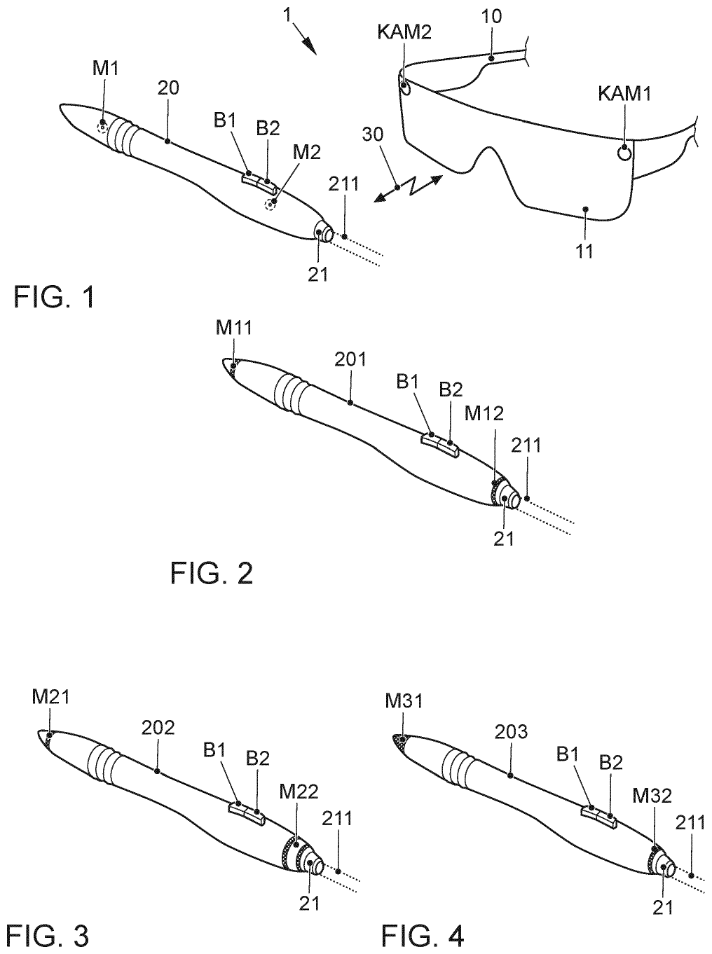

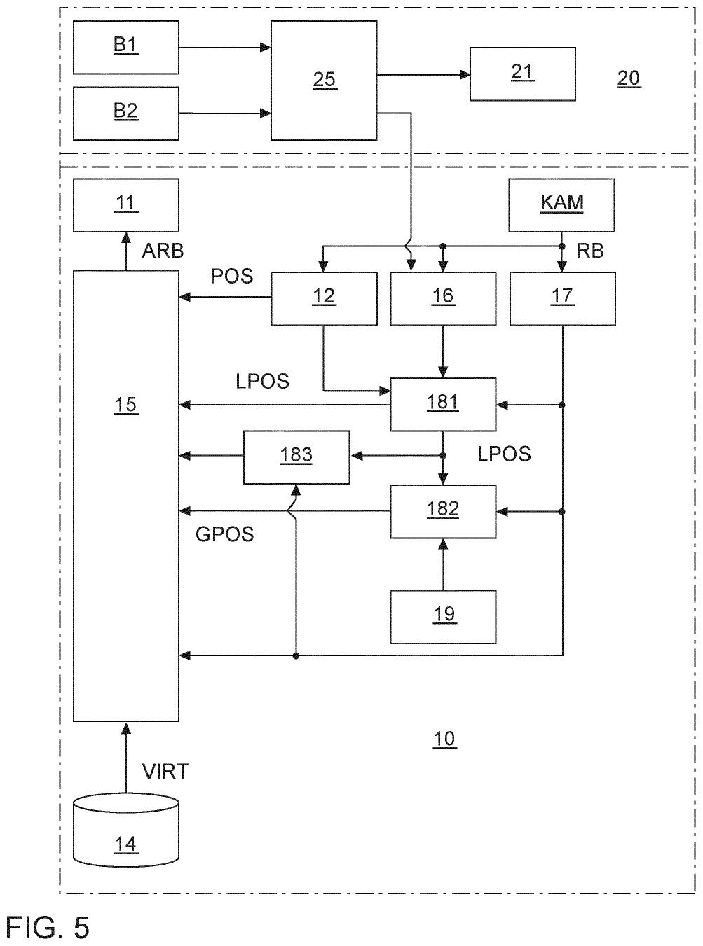

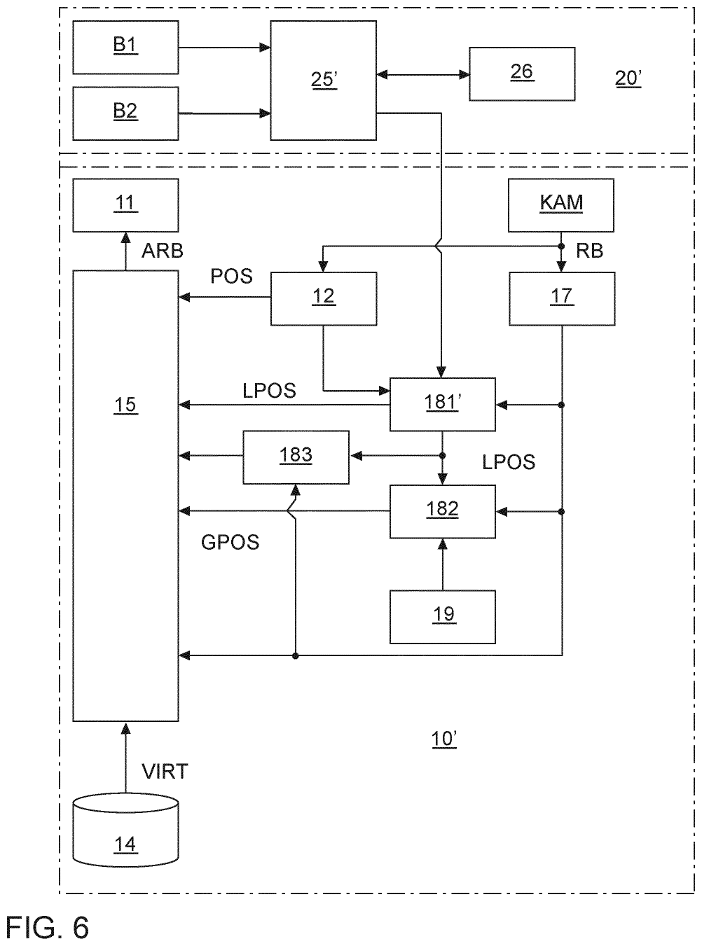

FIG. 1 shows an augmented reality system 1 with a headset 10 (worn by a user), and a pin-shaped control element 20 data-linked to the headset 10. The headset 10 comprises a camera assembly KAM (see FIG. 5 and FIG. 6) with at least two cameras KAM1 and KAM2, as well as a transparent display 11. The camera assembly KAM assigned to the display 11, or respectively oriented relative thereto, serves to record a real image RB of the environment seen by a user of the headset 10, or respectively a corresponding object. The real image RB output by the camera assembly KAM is an input signal in a marker-less tracking system 12 that determines the orientation (position/position signal) POS of the real image RB. The orientation (position/position signal) POS of the real image RB is an output signal of the tracking system 12 and input signal in a scene generator 15.

The augmented reality system moreover comprises a database 14 with virtual image components, or another source of virtual image components. From this database 14, or respectively the other source, the scene generator 15 takes a virtual image component VIRT that is positioned at a specific location so that it may be displayed at this location by the transparent display. The overlap between reality and the virtual image component is in the eye of the user.

The control element 20 comprises a marker M1 and a marker M2 as well as a light source 21 for emitting a light beam 211. The control element 20 moreover comprises two control elements B1 and B2 for operating a light source 21, or respectively for triggering the recognition of a point or a region that is marked by the light beam 211.

FIG. 2, FIG. 3 and FIG. 4 show alternative embodiments of the pin-shaped control element 20 that, relative to the marker, differ therefrom. Accordingly, the pin-shaped control element 201 shown in FIG. 2 comprises two ring-shaped markers M1 and M2. In the two exemplary embodiments according to FIG. 3 and FIG. 4, the corresponding pin-shaped control elements 202 and 203 have distinguishable markers, wherein the marker of the pin-shaped control element 202 identified with reference sign M21 is designed as a ring, and the marker of the pin-shaped control element 202 identified with reference sign M22 is designed as a double ring. The pin-shaped control element 203 shown in FIG. 4 is designed as a cap with the marker identified with reference sign M31, and the marker identified with reference sign M32 is designed as a ring.

FIG. 5 shows the augmented reality system 1 in a schematic diagram. FIG. 5 shows the basic design of an exemplary embodiment of the control element 20 as well as the headset 10. The control element 20 comprises a light source control 25 for controlling the light source 21 depending on an operation of the control elements B1 and/or B2. In doing so, the control element B1 in an exemplary embodiment serves to turn the light source 21 on and off, and the control element B2 serves to select a position that is illuminated by the light source 21, or respectively its light beam 211. An interface may be provided between the control element 20 and the headset 10 by means of which information on the actuation of the light source 21 is supplied by means of the light source control to a light source recognition 16. In doing so, it may for example be provided that a certain code and/or a pulse pattern is transmitted by the light source control 25 to the light beam recognition 16 so that it may recognize it to mark an object, or a position, or the like in the environment, so that a local position recognition module 181 may ascertain the position LPOS marked by the light beam 211.

Optionally, a global position recognition module 182 may be provided that interacts with a GPS or a similar positioning system 19 so that the local position LPOS may be converted into a global or absolute position GPOS, i.e., a position in earth coordinates.

A separation module 183 may also be provided, by means of which sections may be separated from the real image RB such that a section is marked by a local position signal LPOS defining the section. The local position identification module 181, the global position identification module 182 and the separation module 183 are operated for example by the gesture recognition module 17, wherein the gestures may be performed by a hand of a user, or by means of the control element 20. The gesture recognition module 17 interacts with the scene generator 15, or respectively the display 11 such that, by means of the display 11, e.g. selection options, menus, lists, menu structures or the like may be depicted, wherein by means of the gesture recognition module 17, certain entries that are shown by the display 11 may be selected and/or chosen.

FIG. 6 shows a modification of the augmented reality system 1 with a control element 20′ and a headset 10′, wherein the light source is replaced by the light-based rangefinder 26. This is controlled and evaluated via the altered light source control 25′. The ascertained distance between the control element 20′ and a marked object is supplied to the headset 10′, or respectively a local position identification module 181′ that ascertains a marked local position LPOS depending on the orientation of the control element 20′ recognized by the markers M21, M22, M31, M32 and the distance.

The control element 20, or respectively 20′ may be used to link texts, or drawings, or markings to a real location. If for example an athlete is performing exercises in a parcourse, he notes which exercises are being performed in a real room with the control element 20, or respectively 20′. If he redoes his training in the subsequent week, the athlete may display his exercise instructions on the display 11. This information may for example optionally be, or be made, accessible to:
just the user,
his selected contacts,
a certain addressee and/or
a network.

To whom the data are made accessible can, for example, be selected via the gesture recognition module 17 in conjunction with the display 11 (and the selection menu shown therewith).

By means of the control element 20, or respectively 20′, objects may also be selected in a real room (furniture or the like), and the headset 20, or respectively 20′ may be instructed to digitize the geometry in order to, for example, verify a different location therewith. If for example an object is attractive in a furniture store, it may be scanned and placed at home. Conversely, the dimensions of a room may also be measured with the control element 20, or respectively 20′, in order to digitize them.

Another example of a use of the augmented reality system 1 may consist of creating a shopping list and sharing this information via the interface such as Google maps: For example, a user specifies the supermarket XY so that another user sees a shopping list when he visits the supermarket. This other user may delete something from the list every time it is placed in the shopping cart.

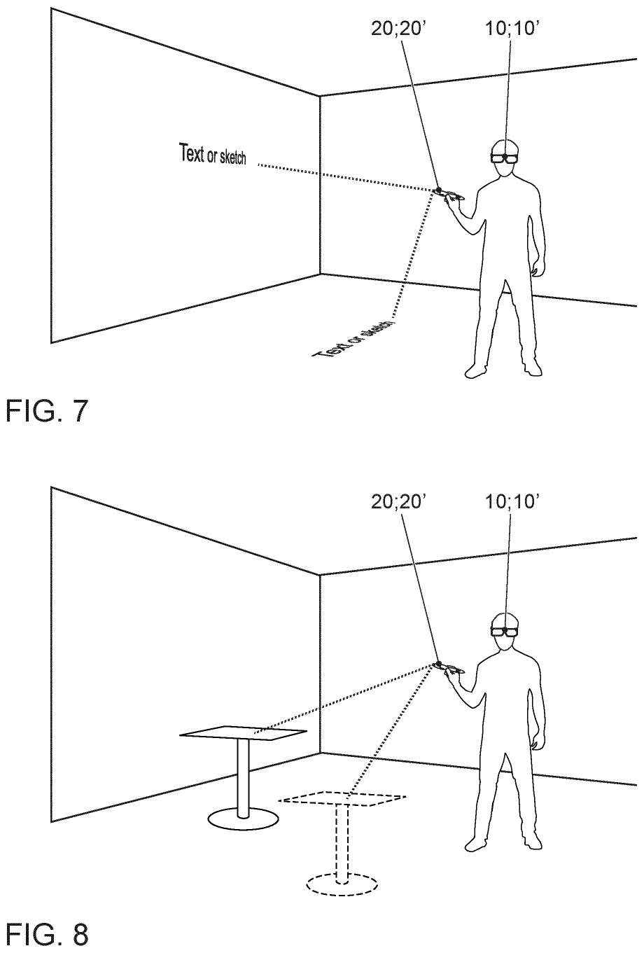

FIG. 7 shows another example of a scenario for using the control element 20, or respectively 20′, or respectively the augmented reality system 1. In doing so, as shown in FIG. 7, the control element 20 (as well as 201, 202, 203), or respectively 20′, may make it possible to write or draw on a surface and/or on several surfaces available in a real room. The headset 10, or respectively 10′ saves this spatial relationship.

In another example of a scenario according to FIG. 8, the control element 20 (as well as 201, 202, 203), or respectively 20′ makes it possible to select an object such as an imaged table and/or several objects. This supports saving views or an optical measurement made with the headset 10. It may accordingly be provided that the headset 10 requests (by means of the display 10) various corner points for markers (closest point, furthest point, etc.).

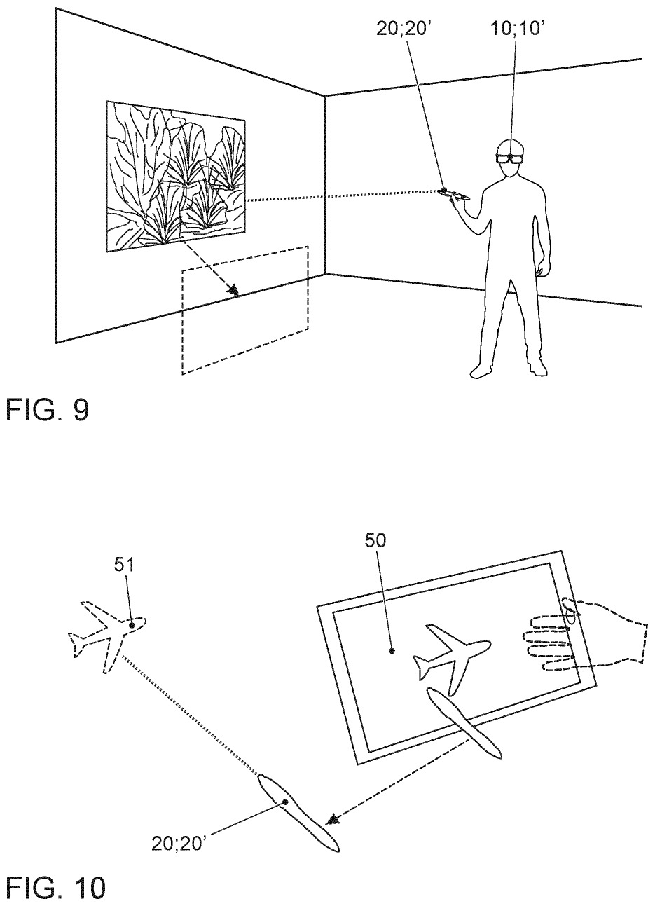

Moreover, by framing a desired object, the control element 20 (as well as 201, 202, 203), or respectively 20′—as shown in FIG. 9—makes it possible to digitize a selection made by framing.

Moreover, the control element 20 (as well as 201, 202, 203), or respectively 20′—as shown in FIG. 10—makes it possible to select an object, a document or a file by a touch function similar to a touchpad, and then project it in a real room by the display 11 in the headset 10 or respectively 10′. Accordingly in FIG. 10, for example an airplane 51, or respectively the depiction of an airplane 51 on a tablet 50, is selected, and projected into the real room by the display 11 of the headset 10.

The invention has been described in the preceding using various exemplary embodiments. Other variations to the disclosed embodiments may be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, module or other unit or device may fulfil the functions of several items recited in the claims.

The term “exemplary” used throughout the specification means “serving as an example, instance, or exemplification” and does not mean “preferred” or “having advantages” over other embodiments. The term “in particular” used throughout the specification means “serving as an example, instance, or exemplification”.

The mere fact that certain measures are recited in mutually different dependent claims or embodiments does not indicate that a combination of these measures cannot be used to advantage. Any reference signs in the claims should not be construed as limiting the scope.

What is claimed is:

1. A control element, wherein the control element comprises a first marker and a second marker for determining the orientation of the control element, and a light source for emitting a light beam.

2. The control element of claim 1, comprising an interface to a headset.

3. An augmented reality system with a headset that comprises a transparent display, by means of which a virtual image component may be depicted, wherein the headset has a camera assembly for recording an image of an environment of the headset as well as a tracking system for determining a position of the virtual image component on the transparent display depending on the image of the real environment, wherein the augmented reality system has a control element of claim 1.

4. The augmented reality system of claim 3, wherein the headset and the control element are data-linked.

5. The augmented reality system claim 3, wherein the headset or the augmented reality system has a local position-recognition circuit for recognizing a point or a region of the environment of the headset marked by the light beam.

6. A method for operating an augmented reality system, wherein a point or a region of the environment of the augmented reality system is marked in the field of vision of the transparent display by the light beam.

7. The method of claim 6, wherein the marked point or region is assigned a local position or a global position.

8. The method of claim 7, wherein the local position or the global position is assigned a function.

9. The of claim 6, wherein the marked region is one or more of measured and removed.

10. The control element of claim 1, configured as a pin-like/elongated control element.

11. The control element of claim 1, configured as a control element in the form of a pin.

12. An augmented reality system with a headset that comprises a transparent display, by means of which a virtual image component may be depicted, wherein the headset has a camera assembly for recording an image of an environment of the headset as well as a tracking system for determining a position of the virtual image component on the transparent display depending on the image of the real environment, wherein the augmented reality system has a control element of claim 2.

13. The augmented reality system of claim 3, wherein the headset and the control element are data-linked by a wireless communication system.

14. The augmented reality system of claim 12, wherein the headset and the control element are data-linked.

15. The augmented reality system of claim 12, wherein the headset and the control element are data-linked by a wireless communication system.

16. The augmented reality system of claim 4, wherein the headset or the augmented reality system has a local position-recognition circuit for recognizing a point or a region of the environment of the headset marked by the light beam.

17. The method of claim 6, wherein the augmented reality system is configured according to claim 3.

18. The method of claim 6, wherein the augmented reality system is configured according to claim 4.

19. The method of claim 6, wherein the augmented reality system is configured according to claim 5.
